(19) United States
(12) Patent Application Publication
(10) Pub. No.: US 2003/0149784 A1
(43) Pub. Date: Aug. 7, 2003

(54) Transosing a bi-directional s2m data stream for transmission via a low-voltage network

(76) Inventors: Hans-Dieter Ide, Dortmund (DE); Ralf Neuhaus, Lunen (DE); Joerg Stolle, Mulheim (DE)

Correspondence Address: BELL, BOYD & LLOYD, LLC, P. O. BOX 1135, CHICAGO, IL, 60690-1135, US

(21) Appl. No.: 10/169,243

(22) PCT Filed: Dec. 19, 2000
(86) PCT No.: PCT/DE00/04547

(30) Foreign Application Priority Data
Dec. 30, 1999 (DE) 199-63-817.9

(51) Int. Cl. G06F 15/16

(52) U.S. Cl. 709/231

(57) ABSTRACT

The pseudo-ternary S₂ₘ data stream consisting of a sequence of S₂ₘ frames (S2mR) is transposed into a binary data stream consisting of a sequence of binary frames (BR). The useful information contained in a binary frame (BR) is then separated from the binary frame (BR) and subsequently compressed. In a following step, the compressed useful information is combined with the uncompressed information of the binary frame (BR) to form a compressed binary frame (KBR). Finally, the compressed binary frames (KBR) are inserted into a transmission packet provided for transmission via the low-voltage network (NSN) and are forwarded to a transmission unit (UEE) for transmission via the low-voltage network (NSN).

The major development in the telecommunications market in recent years has resulted in the search for previously unused transmission capacitors becoming more important, and in attempts being made to use the existing transmission capacitors more efficiently. One known data transmission method is the transmission of data via a power supply network, frequently referred to in the literature as ‘Powerline Communication’, or ‘PLC’ for short. One advantage of using a power supply network as a medium for data transmission is that the network infrastructure already exists. Virtually every building thus has both access to the power supply network and an existing, widely distributed, in-house power network.

In Europe, the power supply network is subdivided into various network structures or transmission levels, depending on the type of power transmission. The high-voltage level with a voltage range from 110 kV to 380 kV is used for power transmission over long distances. The medium-voltage level with a voltage range from 10 kV to 38 kV is used to carry the electrical power from the high-voltage network to the vicinity of the consumer, where it is reduced for the consumer by means of suitable network transformers to a low-voltage level with a voltage range up to 0.4 kV. The low-voltage level is in turn subdivided into a so-called called outdoor area—also referred to as the ‘last mile’ or ‘access area’—and into a so-called in-house area—also referred to as the ‘last meter’. The outdoor area of the low-voltage level defines the area of the power supply network between the network transformer and a meter unit which is associated with each consumer. The in-house area of the low-voltage level is defined by the area between the meter unit and the access units for the consumer.

In Europe, EN Standard 50065 defines four different frequency bands for data transmission via the power supply network—frequently referred to as CENELEC Bands A to D in the literature—with a permissible frequency range from 9 kHz to 148.5 kHz and in each case one maximum permissible transmission power, and these are reserved solely for data transmission on the basis of ‘Powerline Communication’. The narrow bandwidth available in this frequency range and the restricted transmission power mean, however, that data transmission rates of only a few 10 s of kilobits per second can be achieved in this case.

However, data transmission rates in the region of several megabits per second are generally required for telecommunications applications, such as transmission of speech data. The provision of a data transmission rate such as this necessitates in particular a sufficiently wide transmission bandwidth, and this is dependent on a frequency spectrum up to 20 MHz with a suitable transmission response. At the moment, data transmission in the frequency range up to 20 MHz with a suitable transmission response is feasible only in the low-voltage level of the power supply network.

In addition to the bandwidth, the transmission of digital speech data results in stringent requirements with respect to the real-time capability and the maximum permissible bit error rate—BER for short—of the data transmission system. In addition, the transmission of digital speech data is dependent on collision-free point-to-multipoint data transmission with full-duplex operation, that is to say error-free, simultaneous data transmission in both transmission directions between a number of subscribers. One known data transmission method for the transmission of digital speech data is the ISDN transmission method (Integrated Services Digital Network). Data transmission using the ISDN transmission method and satisfying the abovementioned conditions is feasible, by way of example, on the basis of the known S₂ₘ interface—frequently also referred to as a primary multiplex access or ‘PCM Highway’ (Pulse Code Modulation) in the literature.

The present invention is based on the object of providing measures which allow an S₂ₘ interface to be converted for data transmission on the basis of ‘Powerline Communication’.

According to the invention, this object is achieved by the features of patent claims 1 and 14.

One major advantage of the method according to the invention and of the apparatus according to the invention is that the conversion of the known S₂ₘ interface for data transmission on the basis of ‘Powerline Communication’—in particular via the outdoor area of the low-voltage power network—allows digital speech data to be transmitted by means of conventional ISDN communications devices, without any separate, complex access to a digital communications network, for a consumer connected to the power supply network.

Advantageous developments of the invention are specified in the dependent claims.

One advantage of the refinements of the invention as defined in the dependent claims is, inter alia, that the use of known compression methods and compression devices, for example based on the speech coding algorithm G.729 as standardized by the ITU-T, makes it possible to reduce, in a simple manner, the bandwidth required for transmission of an S₂ₘ data stream via the low-voltage power network.

An exemplary embodiment of the invention will be explained in more detail in the following text with reference to the drawing, in which:

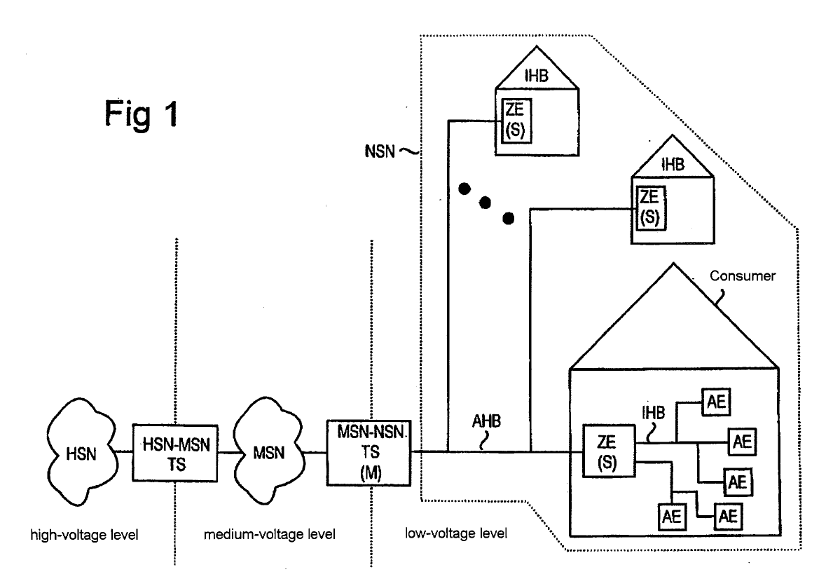

FIG. 1: shows a structogram illustrating a power supply network schematically,

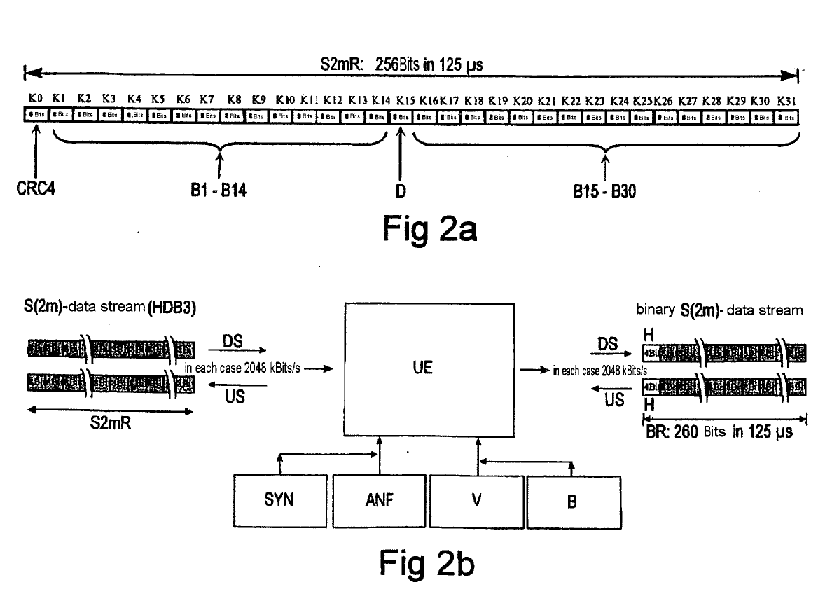

FIG. 2a: shows a structogram illustrating a frame structure for an S₂ₘ data stream schematically;

FIG. 2b: shows a structogram illustrating conversion of an S₂ₘ data stream, coded using an HDB3 channel code, to a binary-coded S₂ₘ data stream, schematically;

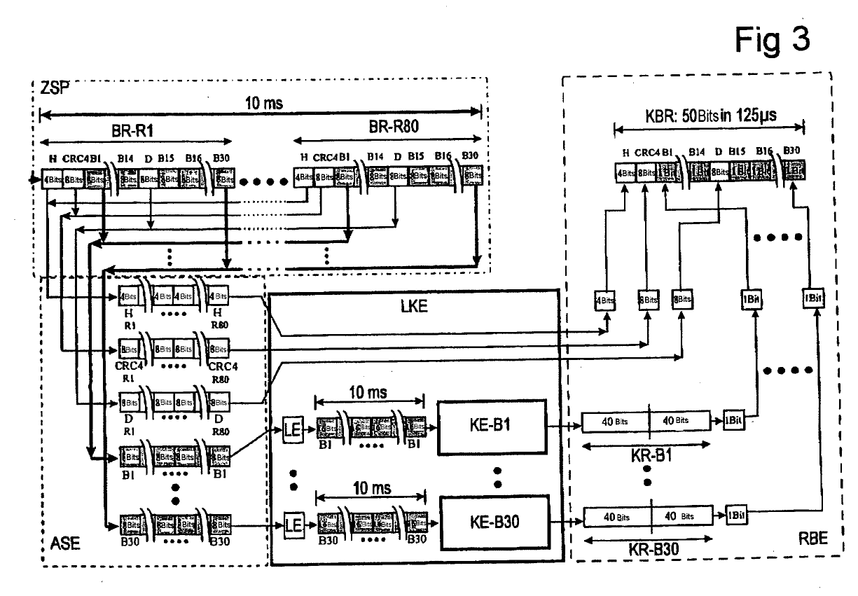

FIG. 3: shows a structogram illustrating compression, carried out by means of a compression unit, of the binary-coded S₂ₘ data stream, schematically;

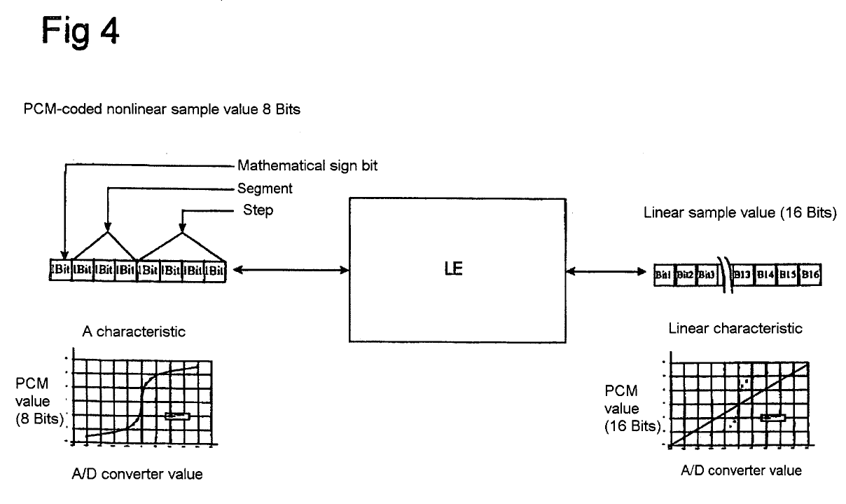

FIG. 4: shows a structogram illustrating linearization of the binary-coded S₂ₘ data stream, schematically;

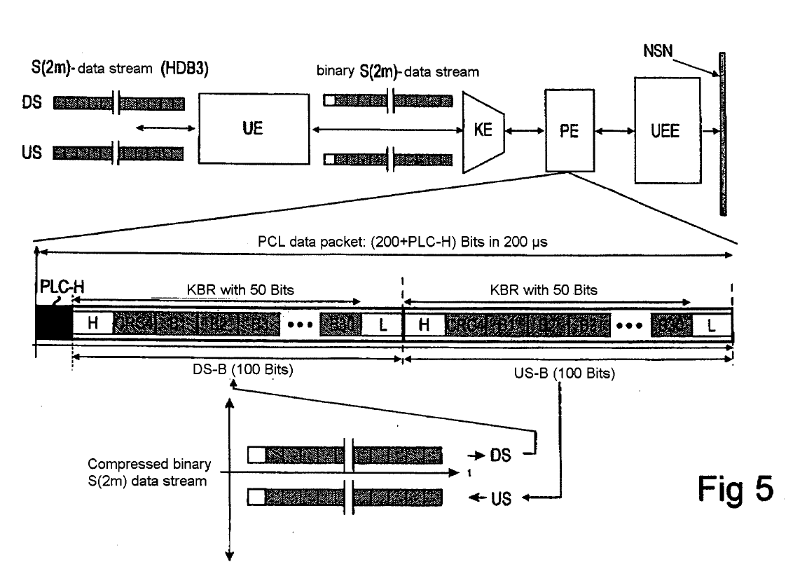

FIG. 5: shows a structogram illustrating a first embodiment of the conversion of the S₂ₘ data stream for transmission via a low-voltage network, schematically;

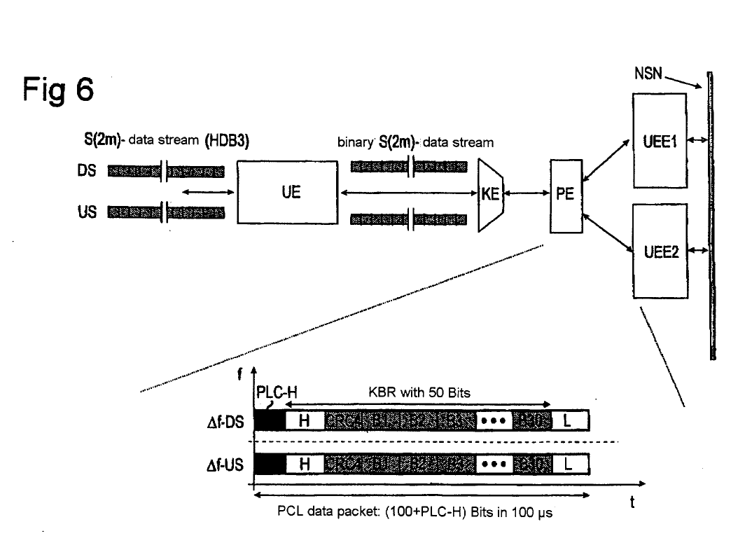

FIG. 6: shows a structogram illustrating a second embodiment of the conversion of the S₂ₘ data stream for transmission via a low-voltage network, schematically.

FIG. 1 shows a structogram, illustrating a power supply network schematically. The power supply network is subdivided into various network structures and transmission levels depending on the type of power transmission. The high-voltage level or high-voltage network HSN with a voltage range from 110 kV to 380 kV is used for long-distance power transmission. The medium-voltage level or medium-voltage network MSN with a voltage range from 10 kV to 38 kV is used to carry the electrical power from the high-voltage network to the vicinity of the consumer. The medium-voltage network MSN is in this case connected to the high-voltage network HSN via a transformer station HSN-MSN TS, which converts the respective voltages. In addition, the medium-voltage network MSN is connected to the low-voltage network NSN via a further transformer station MSN-NSN TS.

The low-voltage level or the low-voltage network with a voltage range up to 0.4 kV is subdivided into a so-called outdoor area AHB and a so-called in-house area IHB. The outdoor area AHB is defined by the area of the low-voltage network NSN between the further transformer station MSN-NSN TS and a meter unit ZE which is associated with each consumer. A number of in-house areas IHB are connected through the outdoor area AHB to the further transformer station MSN-NSN TS, which provides the conversion to the medium-voltage network MSN. The in-house area IHB is defined by the area from the meter unit ZE to access units AE which are arranged in the in-house area IHB. By way of example, an access unit AE is a plug socket connected to the low-voltage network NSN. In this case, the low-voltage network NSN in the in-house area IHB is generally designed in the form of a tree network structure, with the meter unit ZE forming the root of the tree network structure.

A transmission bandwidth of several megabits per second with a suitable transmission response is required for transmission of digital speech data—in particular based on the S₂ₘ interface—via the power supply network, and at the moment this can be achieved only in the low-voltage network NSN. The S₂ₘ interface uses a so-called ‘HDB-3 channel code’ (High Density Bipolar), as the standard line code and this is converted to a binary code for conversion of the S₂ₘ interface for data transmission via the low-voltage network NSN.

FIG. 2a shows a structogram, illustrating a frame structure of the S₂ₘ data stream, schematically. For each of the two transmission directions, an S₂ₘ data stream comprises a sequence of so-called S₂ₘ frames S2mR, which have to be transmitted successively. An S₂ₘ frame S2mR is subdivided into 32 channels K0, . . . , K31, which each have a length of 8 bits. One S₂ₘ frame S2mR in this case essentially has 30 payload data channels B1, . . . , B30, which are each configured as ISDN-oriented B channels with a transmission bit rate of 64 kilobits per second in each case, and a signaling channel D, which is configured as an ISDN-oriented D channel with a transmission bit rate of 64 kilobits per second. Frame control information is transmitted via the first channel K0 using the CRC4 procedure (Cyclic Redundancy Checksum). The payload data information which is associated with the payload data channels B1 to B14 is transmitted via the channels K1, . . . , K14, the signaling information which is associated with the signaling channel D is transmitted via the channel K15, and the payload data information which is associated with the payload data channels B15 to B30 is transmitted via the channels K16, . . . , K31. The frame duration for one S₂ₘ frame S2mR is 125 μs, so that this results in a transmission bit rate of

(32×8 Bits)/125 μs=2048 kilobits per second per S₂ₘ frame S2mR.

FIG. 2b shows a structogram illustrating the conversion of an S₂ₘ data stream, coded using the HDB3 channel code, to a binary-coded S₂ₘ data stream, schematically. The HDB-3 channel code is a pseudoternary line code, in which the two binary states “0” and “1” are represented by the three signal potentials ‘0’, ‘1’ and ‘−1’. In this case, the binary state “1” is represented by the signal potential ‘0’. The binary state “0” is associated either with a positive signal potential ‘1’ or with a negative signal potential ‘−1’. In order to avoid the transmission of long strings of zeros, a characteristic data sequence is inserted in the HDB channel code when more than n successive zeros are transmitted. A characteristic ‘1/−1’ combination is thus added after 3 zeros in the HDB-3 channel code (n=3).

4-wire transmission is generally provided for bidirectional data transmission via the S₂ₘ interface, with the two transmission directions—referred as the downstream direction DS and the upstream direction US in the following text—being carried via separate lines. The downstream direction DS is in this case defined as data transmission via a transmission path from a central device—referred to as the ‘Master’ M in the following text—which controls the transmission to further devices—referred to as ‘Slaves’ S in the following text—which are connected to the transmission path. The upstream direction US is defined as data transmission from the respective slaves S to the master M. In the case of the present exemplary embodiment, the further transformer station MSN-NSN TS which provides the voltage level conversion between the medium-voltage network MSN and the low-voltage network NSN is configured as the master M—indicated by the M in brackets in FIG. 1—and the meter units ZE which are associated with in each case one in-house area IHB are configured as slaves S—indicated by the S in brackets in FIG. 1.

The figure in each case shows an S₂ₘ frame S2mR in the downstream direction DS and in the upstream direction US for a pseudoternary S₂ₘ data stream coded using the HDB-3 channel code. An S₂ₘ frame S2mR has a frame duration of 125 μs, and has a total of 256 Bits. The conditions for data transmission via the S₂ₘ interface are standardized in the ITU-T (International Telecommunication Union) Specification I.431 “ISDN User-Network Interfaces—Primary Rate User Network Interface—Layer 1”.

The pseudoternary S₂ₘ data stream coded using the HDB-3 channel code is converted by a conversion unit UE to a binary S₂ₘ data stream. In this case, the information (which comprises 256 Bits coded using the HDB-3 channel code) in the S₂ₘ frame S2mR is converted, both for the downstream data stream DS and for the upstream data stream US, to binary-coded information comprising 256 Bits, and is combined by means of a 4-Bit long header H to form a 260-Bit long binary frame BR. The header H in this case comprises a synchronization Bit SYN, an initial state Bit ANF, a V Bit V and a B Bit B. The initial state Bit ANF includes information about the signal potential in the HDB-3 channel code associated with the first “0” state. Since the signal potential for the “0” state may have the potential 1 or −1, this information is necessary to allow the original HDB-3 channel code to be reproduced at the receiver end. The synchronization bit SYN is used for synchronization of the S₂ₘ frames S2mR which are associated with one another and are being produced at the receiver end from the binary frames BR, for the downstream data stream DS and from the upstream data stream US. The V Bit V and the B Bit B are HDB channel-code-specific information for error identification, thus improving the transmission reliability.

This therefore results in an increased transmission rate of

(256+4) Bits/125 μs=2080 kilobits per second

for the binary S₂ₘ data stream, both for the downstream data stream DS and for the upstream data stream US.

In order to reduce the bandwidth required for data transmission via the low-voltage network NSN, the information transmitted in the course of a binary frame BR is compressed. In this case, only the payload data information transmitted in the course of the payload data channels B1, . . . , B30 is compressed. The signaling information transmitted in the course of the signaling channel D and the additional control information CRC4 are transmitted transparently, that is to say without compression.

FIG. 3 illustrates, schematically, a method for compression of the binary-coded S₂ₘ data stream, which comprises a sequence of binary frames BR. Eighty binary frames BR-R1, . . . , BR-R80 with are associated with a transmission direction DS, US are in each case buffer-stored in a memory device ZSP in a compression unit for the compression process. Assuming that the binary frames BR each have a duration of 125 μs, this corresponds to a total duration of 10 ms. The buffer-stored binary frames BR-R1, . . . , BR-R80 are then in each case subdivided in a separation unit ASE into logical units, and are separated from one another. Logical units comprise the header H, the control information CRC4, the signaling channel D and the payload data channels BR, . . . , B30 in each case. The logical units of the binary frames BR-R1, . . . , BR-R80 are then—as illustrated in the figure—combined to form in each case one processing frame, and are passed to a linearization and compression unit LKE. The processing frames which are formed from the header H, the control information CRC4 and the signaling channel D are in this case carried transparently, that is to say without being compressed by the linearization and compression unit LKE.

The processing frames which are associated with the payload data channels B1, . . . , B30 on the other hand, are each supplied to a linearization unit LE in the linearization and compression unit LKE. The processing frame which is associated with a payload data channel B1, . . . , B30 comprises a total of eighty payload data Bytes, which are associated with a respective payload data channel B1, . . . , B30, with one payload data Byte in each case being associated with each binary frame BR-R1, . . . , BR-R80 by the position in the processing frame. The payload data information transmitted in the course of the payload data channels B1, . . . ,B30 is coded, as standard, using a nonlinear so-called A characteristic, with a resolution of 8 Bits. In order to allow known compression methods to be used, the payload data information must be linearized before being compressed. The 8-Bit resolution is converted to 16-Bit resolution at the same time as the linearization. This in each case results in a processing frame with a length of 80×16=1280 Bits, and with a duration of 10 ms, for the payload data channels B1, . . . , B30.

The processing frames with the linear-coded payload data information are then supplied to a respective channel-specific compression unit KE-B1, . . . , KE-B30. The channel-specific compression units KE-B1, . . . , KE-B30 are used to compress the payload data information, as transmitted in the processing frames, using the compression method G.729 as standardized by the ITU-T. This speech coding algorithm converts the linear-coded 16-Bit sample values at a sampling frequency of 8 kHz to an 8 kilobit per second data stream. A speech segment with a duration of 10 ms—in the present exemplary embodiment this corresponds to payload data information with a length of 1280 Bits—is required for this purpose, for a parameter calculation which has to be carried out in accordance with the algorithm. Compressed processing frames KR-B1, . . . , KR-B30, each having 80 Bits of compressed payload data information and a duration of 10 ms, are thus produced for the payload data channels B1, . . . , B30 at the output of the channel-specific compression units KE-B1, . . . , KE-B30. Other compression methods may also be used as an alternative to the compression method G.729 as standardized by the ITU-T.

The compressed processing frames KR-B1, . . . , KR-B30 are then supplied to a frame formation unit RBE, which separates the compressed payload data information contained in the compressed processing frames KR-B1, . . . , KR-B30 on the basis of the originally uncompressed binary frames BR-R1, . . . , BR-R80, and compiles them with the further information—as illustrated in the figure—which is passed in transparent form through the linearization and compression unit LKE, to form a compressed binary frame KBR. One compressed binary frame KBR thus has 50 Bits of information—30 Bits of payload data information and 20 Bits of additional information—with a duration of 125 μs.

First, in comparison to an uncompressed binary frame BR, the transmission bandwidth required for transmission of a compressed binary frame KBR is reduced from 2080 kilobits per second to 400 kilobits per second. The compressed binary frames KBR are then transmitted to a transmission unit UEE for feeding into the low-voltage network NSN.

FIG. 4 now shows, illustrated schematically, a method for linearization of the payload data information combined in the processing frames. The payload data information transmitted in the payload data channels B1, . . . , B30 is coded by means of pulse code modulation, or PCM for short. The pulse code modulation uses a nonlinear, so-called A characteristic for coding.

The A characteristic is composed of a total of 13 segments. According to the ITU-T definition, each amplitude value of a signal to be sampled is represented by 8 Bits. The first Bit indicates the mathematical sign of the sampled signal. The next 3 Bits define the relevant segment of the A characteristic, and the last 4 Bits define a quantization step within one segment. Overall, this thus results in 256 possible quantization steps.

The linearization unit LE converts the payload data information, coded using the nonlinear A characteristic, to a signal which is coded using a linear characteristic. At the same time, the 8-Bit resolution used by the A characteristic is converted to 16-Bit resolution. The use of linear coding with 16-Bit resolution satisfies the preconditions for use of the compression method in accordance with ITU-T Standard G.729 after the linearization process.

FIG. 5 shows a structogram, schematically illustrating a first embodiment of the conversion of the pseudoternary S₂ₘ data stream, coded using the HDB-3 channel code, for transmission via the low-voltage network NSN. In a first step, the pseudoternary S₂ₘ data stream coded using the HDB-3 channel code is converted by the conversion unit UE—as described with reference to FIG. 2—to a binary-coded S₂ₘ data stream. The binary-coded S₂ₘ data stream, comprising a sequence of binary frames BR, is then passed to a compression unit KE, which linearizes the binary-coded S₂ₘ data stream—as described with reference to FIG. 3 and FIG. 4—and compresses it. In a next step, the compressed S₂ₘ data stream is passed to a protocol unit PE, which converts it to a data format intended for data transmission via the low-voltage network NSN.

A master-slave communication relationship is set up on the basis of the tree structure in the outdoor area AHB of the low-voltage network NSN, for data transmission between the consumers which are connected to the low-voltage network NSN and the transformer station MSN-NSN TS which provides the voltage level conversion between the medium-voltage network MSN and the low-voltage network NSN. In this case, the transformer station MSN-NSN TS which forms the root of the tree structure is defined as the master M, and the meter units ZE which are associated with the respective consumers are defined as slaves S.

So-called PLC data packets, each having a length of 200 Bits and a duration of 200 μs, are provided for data transmission via the low-voltage network NSN, and are subdivided into a PLC header PLC-H and a payload data area. The PLC header PLC-H essentially comprises address information for addressing the slaves S connected to the low-voltage network NSN. The address information may in this case be formed by a MAC address (Medium Access Control) which is uniquely associated with each of the slaves S. The MAC address is a unique hardware address, which resides in layer 2 of the OSI reference model and has a length of 6 Bytes. Alternatively, the slaves S which are connected to the low-voltage network NSN may be addressed by means of VPI/VCI addressing (Virtual Path Identifier/Virtual Channel Identifier) based on the ATM protocol (Asynchronous Transfer Modus).

In order to provide bidirectional data transmission via the low-voltage network NSN, the payload data area of the PLC data packet is subdivided using the time-division duplexing method—also referred to as ‘Time Division Duplex’ or ‘TDD’ for short in the literature—into two frames—also referred to as duplex areas in the literature. In this case, the payload data area is subdivided into a downstream area DS-B and into an upstream area US-B. The compressed binary frames KBR, which essentially arrive at the same time, in the downstream data stream DS and in the upstream data stream US in the binary-coded, compressed S₂ₘ data stream are in this case inserted, successively in time, in the respective downstream or upstream area DS-B, US-B of the payload data area of the PLC data packet.

The downstream area DS-B and the upstream area US-B each have a length of 100 Bits, with a duration of 100 μs. In order to make it possible to insert a compressed binary frame KBR with a length of 50 Bits and a duration of 125 μs into the corresponding duplex area DS-B, US-B, the compressed binary frames KBR must be buffer-stored. In addition, the free area in the payload data area of the PLC data packet which results from the different length of the duplex areas DS-B, US-B and of the compressed binary frames KBR is filled by blank data L.

The PLC data packets are then transferred from the protocol unit PE to a transmission unit UEE for transmission via the low-voltage network NSN. The transmission unit UEE carries out the data transmission process, by way of example, using the OFDM transmission method (Orthogonal Frequency Division Multiplex) with upstream FEC error correction (Forward Error Correction) and upstream DQPSK modulation (Differential Quadrature Phase Shift Keying). Further information relating to these transmission and modulation methods can be found from the diploma work by Jörg Stolle: “Powerline Communication PLC”, 5/99, Siemens A G, which has not yet been published.

In this first conversion mode, the payload data area of the PLC data packet is subdivided into two duplex areas, each having a length of 100 Bits. This thus results—ignoring the PLC header—in a required transmission bit rate of:

(200 Bits)/200 μs=1 microbits per second

FIG. 6 shows a structogram, schematically illustrating a second embodiment of the conversion of the pseudoternary S2m data stream, coded using the HDB-3 channel code, for transmission via the low-voltage network NSN. Analogously to the first embodiment, the pseudoternary S₂ₘ data stream, coded using the HDB-3 channel code, is in the first step converted by the conversion unit UE—as described with reference to FIG. 2—to a binary-coded S₂ₘ data stream. The binary-coded S₂ₘ data stream, which comprises a sequence of binary frames BR, is then passed to a compression unit KE, which linearizes and compresses the binary-coded S₂ₘ data stream—as described with reference to FIG. 3 and FIG. 4. In a next step, the compressed S₂ₘ data stream is passed to a protocol unit PE, which converts it to a data format which is intended for data transmission via the low-voltage network NSN.

According to the second embodiment, different PLC data packets are defined for the downstream data stream DS and for the upstream data stream US for the implementation of bidirectional data transmission via the low-voltage network NSN, and these are shifted by modulation to two different frequency bands Δf-DS, Δf-US by means of the frequency duplexing method—frequently referred to as ‘Frequency Division Duplex’ or ‘FDD’ for short in the literature.

The PLC data packets defined for the downstream data stream DS and for the upstream data stream US each have a length of 100 Bits with a duration of 100 μs. In order to allow a compressed binary frame KBR with a length of 50 Bits and a duration of 125 μs to be inserted into the corresponding duplex area DS-B, US-B, the compressed binary frames KBR must be buffer-stored, in an analogous manner to the first embodiment. In addition, the free area in the payload data area of the PLC data packet resulting from the different lengths of the payload data areas of the PLC data packets and from the compressed binary frames KBR is filled by blank data L.

The PLC data packets are then transferred from the protocol unit PE to a first transmission unit UEE1 and to a second transmission unit UEE2, as appropriate, for transmission via the low-voltage network NSN. The first and the second transmission units UEE1, UEE2 provide the data transmission for example in accordance with the OFDM transmission method, with upstream FEC error correction and upstream DQPSK modulation. In this case, by way of example, the first transmission unit UEE1 controls the data transmission via the low-voltage network NSN in a first frequency band Δf-DS, and the second transmission unit UEE2 controls the data transmission in a second frequency band Δf-US.

In this second conversion mode, the PLC data packets have a length of 100 Bits and a duration of 100 μs.

This therefore results in a required transmission rate of:

(100 Bits)/125 μs=500 kilobits per second.

in each case for the downstream direction DS and for the upstream direction US.

At the receiver end, the PLC data packets are read from the low-voltage network NSN and are converted to a pseudoternary S₂ₘ data stream, coded using the HDB-3 channel code, analogously to the described method of operation, but in the opposite direction.

1. A method for conversion of an S₂ₘ data stream for transmission via a low-voltage power network (NSN),
in which the pseudoternary S₂ₘ data stream, which comprises a sequence of S₂ₘ frames (S2mR) is converted to a binary data stream which comprises a sequence of binary frames (BR),
in which payload information which is contained in a binary frame (BR) is separated from the binary frame (BR) and is then compressed,
in which the compressed payload information is combined with the uncompressed information in the binary frame (BR) to form a compressed binary frame (KBR), and
in which the compressed binary frames (KBR) are inserted into transmission packets, which are intended for data transmission via the low-voltage power network (NSN), and are passed to a transmission unit (UEE) for transmission via the low-voltage power network (NSN).

2. The method as claimed in claim 1, characterized in that
a master-slave communication relationship is set up for data transmission via the low-voltage power network (NSN).

3. The method as claimed in claim 1 or 2, characterized in that
a time-division duplexing method (Time Division Duplex TDD) is used to subdivide the transmission packets into a first area (DS-B) for data transmission in a first transmission direction (DS), and into a second area (US-B) for data transmission in a second transmission direction (US), and
in that the compressed binary frames (KBR) are inserted into the first area or the second area (DS-B, US-B) of the transmission packet, depending on the direction.

4. The method as claimed in claim 3, characterized in that
compressed binary frames (KBR) are transmitted from a master device (M) to a slave device (S) in the first area (US-B), and compressed binary frames (KBR) are transmitted from the slave device (S) to the master device (M) in the second area (US-B).

5. The method as claimed in claim 3 or 4, characterized in that
the locations of the first area and of the second area (DS-B; US-B) which do not contain any information after insertion of a compressed binary frame (KBR) into the respective area (DS-B, US-B) are filled with blank data (L).

6. The method as claimed in claim 1,
characterized in that first transmission packets, which are intended for data transmission in a first transmission direction (DS), are modulated by means of a frequency-division duplexing method (Frequency Division Duplex FDD) into a first frequency band (Δf-DS), and second transmission packets, which are intended for data transmission in a second transmission direction (US), are modulated into a second frequency band (Δf-US),
in that the compressed binary frames (KBR) are inserted into the first or second transmission packets depending on the direction,
and in that the first transmission packets are passed to a first transmission unit (UEE1), and the second transmission packets are passed to a second transmission unit (UEE2), for transmission via the low-voltage power network (NSN).

7. The method as claimed in claim 6, characterized in that compressed binary frames (KBR) are transmitted from a master device (M) to a slave device (S) in the first transmission packets, and compressed binary frames (KBR) are transmitted from the slave device (S) to the master device (M) in the second transmission packets.

8. The method as claimed in claim 6 or 7, characterized in that
those locations in the first and in the second transmission packets which do not contain any information after insertion of a compressed binary frame (KBR) into the respective transmission packet are filled with blank data (L).

9. The method as claimed in one of the preceding claims, characterized in that,
during the conversion of an S₂ₘ frame (SR) to a binary frame (BR), information is inserted for recovery of the S₂ₘ frame (SR).

10. The method as claimed in claim 8, characterized in that
an initial status bit (ANF), a synchronization bit (SYN), a V bit (V) and a B bit (B) are inserted into the binary frame (BR) as information.

11. The method as claimed in one of the preceding claims characterized in that
the payload information is compressed using the compression method G.729 standardized by the ITU-T.

12. The method as claimed in claim 11, characterized in that
the payload information which is associated with a respective payload data channel (B1, . . . , B30) is compressed separately in a respective channel-specific compression device (KE-B1, . . . , KE-B30).

13. The method as claimed in claim 11 or 12, characterized in that
the payload information, which is coded using a nonlinear A characteristic and has 8-bit resolution, is converted, before being compressed, to a linear signal which has 16-bit resolution.

14. An apparatus for conversion of an S₂ₘ data stream for transmission via a low-voltage power network (NSN), having a conversion unit (UE) for conversion of the pseudoternary S₂ₘ data stream, which comprises a sequence of S₂ₘ frames (S2mR) to a binary data stream which comprises a sequence of binary frames (BR),
having a separation unit (ASE) for separation of payload information which is contained in a binary frame (BR), and having a compression unit (KE) for compression of the separated payload information,
having a frame formation unit for combination of the compressed payload information with the uncompressed information in the binary frame (BR) to form a compressed binary frame (KBR),
having a protocol unit (PE) for insertion of the compressed binary frames (KBR) into a transmission packet which is intended for data transmission via the low-voltage power network (NSN), and
having a transmission unit (UEE) for feeding the transmission packets into the low-voltage power network (NSN).

15. The apparatus as claimed in claim 14, characterized in that
the compression unit (KE) is designed on the basis of the compression method G.729 standardized by the ITU-T.

16. The apparatus as claimed in claim 14 or 15, characterized in that
the compression unit (KE) has thirty channel-specific compression units (KE-B1, . . . , KE-B30).

17. The apparatus as claimed in claim 16, characterized in that
the channel-specific compression units (KE-B1, . . . , KE-B30) are each preceded by a linearization unit (LE) for conversion of the payload information, which is coded using a nonlinear A characteristic and has 8-bit resolution, to a linear signal which has 16-bit resolution.

18. The apparatus as claimed in one of claims 14 to 17, characterized in that
the protocol unit (PE) is designed such that
a time-division duplexing method (Time Division Duplex TDD) is used to subdivide the transmission packets into a first area (DS-B) for data transmission in a first transmission direction (DS), and into a second area (US-B) for data transmission in a second transmission direction (US), and
the compressed binary frames (KBR) are inserted into the first area or the second area (DS-B, USB) of the transmission packet, depending on the direction.

19. The apparatus as claimed in one of claims 14 to 17, characterized in that
the protocol unit (PE) is designed such that
first transmission packets, which are intended for data transmission in a first transmission direction (DS), are modulated by means of a frequency-division duplexing method (Frequency Division Duplex FDD) into a first frequency band (Δf-DS), and second transmission packets, which are intended for data transmission in a second transmission direction (US), are modulated into a second frequency band (Δf-DS), and
the compressed binary frames (KBR) are inserted into the first or second transmission packets depending on the direction.

20. The apparatus as claimed in claim 19, characterized by
a first transmission unit (UEE1) for transmission of the first transmission packets, and a second transmission unit (UEE2) for transmission of the second transmission packets, via the low-voltage power network (NSN).

21. The apparatus as claimed in one of claims 14 to 20, characterized in that
a master-slave communication relationship is set up for data transmission via the low-voltage power network (NSN).

22. The apparatus as claimed in claim 21, characterized in that
a transformer station (MSN-NSN TS) which carries out the voltage conversion between a medium-voltage power network (MSN) and the low-voltage power network (NSN) is configured as the master device (M).

23. The apparatus as claimed in claim 21 or 22, characterized in that
a meter device (ZE), which is associated with a respective in-house area (IHB) of the low-voltage power network (NSN), is configured as the slave device (S).
